(19) United States
(12) Patent Application Publication
(10) Pub. No.: US 2015/0127370 A1
(43) Pub. Date: May 7, 2015

(54) System and Method for Identifying and Correcting Billing Errors in High-Volume Billing and Claim Adjudicating Systems

(71) Applicant: ClaimReturn, LLC, Dallas, TX (US)

(72) Inventor: Dawn M. Cornelis, Corona, CA (US)

(21) Appl. No.: 14/533,592

(22) Filed: Nov. 5, 2014

Related U.S. Application Data
(60) Provisional application No. 61/900,651, filed on Nov. 6, 2013.

(51) Int. Cl. G06Q 30/04; G06F 19/00; G06Q 50/22

(52) U.S. Cl. CPC G06Q 30/04; G06Q 50/22; G06F 19/328
USPC 705/2

(57) ABSTRACT

A system and method identifies coding errors in claims for an episode of medical care, comprising in combination a process that translates into one format, input claims data that encode multiple health care services delivered in an episode of care for a patient; a process that pre-sorts the claim data by excluding claim data that is incorrect, incomplete, duplicated, and improperly formatted; a compiling process for gathering claims data for the episode of care; and a coding conflict engine for comparing the data in each claim of the episode of care with the data in all other claims in the episode of care to determine inconsistencies in the record. The results may be processed to decide how to recover incorrect payments.

### CROSS REFERENCE TO RELATED APPLICATIONS

The present application claims priority to U.S. Provisional Patent Application Ser. No. 61/900,651 filed Nov. 6, 2013 and entitled “SYSTEM AND METHOD FOR IDENTIFYING AND CORRECTING BILLING ERRORS IN HIGH-VOLUME BILLING AND CLAIM ADJUDICATING SYSTEMS.”

### BACKGROUND OF THE INVENTION

1. Field of the Invention

The present invention generally relates to a system and method for adjudicating claims submitted by service providers for payment, and more particularly to a system and method for auditing multiple claims in a set of associated claims paid or submitted for payment to determine and recover overpayments.

2. Background of the Invention and Description of the Prior Art

In the highly complex industry of healthcare claim processing medical claims presented for payment are presumed to be accurate on receipt by paying parties (payors) such as insurance companies, government agencies such as Medicare and Medicaid and employers that self-insure their employees. However, this presumption is too often incorrect when the medical claim documents services—typically diagnoses and treatment procedures—that are billed in error, whether through mistake or fraud.

For example, consider a correct billing of $25,000 that was paid for a Care Flight Ambulance service, but later discovered to be uncorroborated by—and therefore in conflict with—any other medical services billed or paid for the named patient within a reasonable time period.

As another real-life example, consider a surgeon's claim that billed for two procedures, correctly billed and timely paid within 30 days, that was associated with an assistant surgeon's bill for the same patient in an episode of patient care that documented five procedures, also correctly billed and timely paid within 60 days. In this case, it is highly unlikely that the assistant surgeon actually performed the three additional procedures alleged in the bill. This is another example of a claim in conflict with a claim in the same episode of care.

There are several reasons this kind of obvious mis-billing error can occur. One is that individual claims for services associated in an episode of care are often processed asynchronously or independently over a period of several days, weeks or even months. For example, bills are processed “on their face” most often by a computer (e.g., 80 to 90% auto adjudication) with systems that are built around capturing discounts and applying contract rates quickly and efficiently but not designed to question the content of the bill or even its efficacy. Moreover, current claims systems do not accumulate history well or question new/incoming bills based upon prior paid bills for the same patient.

Another important reason that a solution has not yet emerged is the sheer volume of information that must be examined—the universe of all paid claims—and the complexity of any possible remedy for discovering and correcting billings containing substantial errors. In addition, the increasing presence of fraud and other abusive practices in the industry where practitioners have learned how to bill in ways that do not raise red flags in the computer systems that process the bills that they submit. Conventional claims adjudicating software and systems too frequently lack the ability to detect such incidents or to perform a sufficiently comprehensive review of services delivered to the patient.

High volume service providers such as health care providers whose billings are adjudicated and paid by payor entities such as insurance company claims administrators must process extraordinarily large amounts of data in handling claims for payment according to billings issued by the service providers. In this type of business environment the opportunities for billing errors, and the economic costs resulting from billing errors are substantial. In an industry where billings run into hundreds of billions of dollars, even an error rate of a few percent—e.g., within a range of 2% to 8%—represents many billions of dollars lost due to errors in billing. The kind of errors include coding errors for procedures and facilities, duplication of services, amounts billed for services that were zeroed out or reversed, services billed but undelivered, mis-identification of patients, facilities, or procedures, and so on.

The problem of auditing, identifying, and recovering overpayments has long resisted adequate solution because of the scale and scope of the problem—the large number of providers and facilities having different skills and expertise, billing rates, etc.; the huge amounts of data that must be processed, the existence of many disparate data processing systems and coding schemes involved in the industry to keep track of health care records and process claims for payment or reimbursement. Typically the medical treatment of a single individual can involve multiple providers and incidents of care, all of which will each form the basis for creating a billing record that becomes part of the total record submitted as a claim for payment.

In the prior art, in order to manage the volume of data, some audit systems approach the task on a statistical basis to reduce the scale of the analysis that must be performed. The drawback of this method is that all individual claims are not evaluated. Instead, only a random sampling of the aggregated claims for a specified period or for a specific type of episode of care, or some other convenient grouping of claims is analyzed. Such a process does not identify with particularity the locus of the errors sufficiently to enable specific recovery actions. Further, the error correction and recovery for the group is only an approximation of the actual overpayment.

In another prior art system, the process looks only at certain kinds of billing errors selected because they are believed to be the most prevalent sources of errors. For example, an audit process may look at claims having coding errors in the Current Procedural Terminology (“CPT”) codes used to identify services delivered to a patient. Or, an audit may look only at billings for duplicate services or undelivered services in a large agglomeration of claims. Again, the recovery from these methods is only partial, and still only an approximation of the actual overpayment in the specific category selected for audit. Both of the foregoing prior art examples are characterized by inefficiency and limited accuracy, not to mention uncertainty as to whether all of the possible recoverable overpayments are in fact being recovered.

A practical way to examine an entire patient record for inconsistencies in billing has eluded solution for some time due in large part to the complexity of the problem. This complexity resulted in systems that are limited to processing certain aspects of the problem, often from the point of view of the particular entity that issues, processes, or provides reimbursement for the claims of particular providers or facilities involved in the patient's encounter with the healthcare system. What is needed is a comprehensive system and method for auditing the claim records of a patient's entire encounter.

### SUMMARY OF THE INVENTION

Accordingly, a system and method are disclosed for thoroughly reviewing all claims transactions submitted for auditing, identifying, and recovering overpayments for services billed by and paid to service providers.

In one embodiment, a system is provided for identifying coding errors in a record of claims for an episode of medical care, comprising a process that translates into one format, input claims data that encode multiple health care services delivered in an episode of care for a patient delivered by two or more providers or facilities; a process that pre-sorts the claim data by excluding claim data that is incorrect, incomplete, duplicated, and improperly formatted; a compiling process for gathering claims data for the episode of care; and a coding conflict engine for comparing the data in each claim of the episode of care with the data in all other claims in the episode of care to determine inconsistencies in the record. In one aspect, the system further comprises a process for segregating inconsistent claims data in the record into a first group for automated recovery processing of a single inconsistent claim or a second group for manual recovery processing of multiple inconsistent claims.

In another embodiment, a coding conflict engine is provided for detecting conflicts in provider claims for medical services, comprising a rules engine configured to examine claims having coded medical provider or facility services associated with an episode of patient care in a sequence of pattern matching steps to cross match codes defining a first claim for the medical provider or facility service as a reference claim with each other claim in the episode of patient care containing medical provider or facility service codes, to identify codes in each examined claim that are in conflict—and therefore inconsistent—with the codes contained in the reference claim, and assign a flag to each code found to be in conflict, wherein the flag represents a medical service billed, processed, and paid but not delivered, and absence of a flag represents coded data that are not in conflict; and a file system to accumulate claims data for the episode of patient care that are processed in the coding conflict engine.

In one aspect the coding conflict engine is configured as a rules engine comprising an interface to a first file for receiving, in sequence, a series of claim data having the coded medical provider or facility services associated with an episode of patient care; a processor for performing the pattern matching steps to cross match codes defining each set of claim data through the codes in the entire sequence of the series of claim data; and an interface to a second file for receiving claim data for the episode of patient care that are flagged for further review.

In another embodiment a method executed by a coding conflict engine in a hosted server environment is provided to detect conflicting medical service and procedure claims submitted by multiple providers and facilities for an episode of patient care, comprising the steps of combining, in a data file created by a claim analysis system from respective databases coupled thereto, billing data of the service providers for the episode of care, claim-by-claim, with output data of payor entities who paid claims for that episode of care; and processing the combined billing and paid claims data in the claim analysis system by executing the following steps in a hosted server environment: loading raw service provider billing data and payor output data expressed in differing formats into the data file in a database system within the hosted server environment; cross walking the claim data fields of the service provider's billing data and the payor's output data, including procedure and facility codes for medical services to prepare data for analysis; scrubbing the cross walked data to amend or remove data that is incorrect, incomplete, improperly formatted, duplicated, or reflecting zero-sum paid; filtering, using unique procedure and facility codes, the scrubbed data for the episode of care according to one or more parameters selected from the group consisting of individual patient identifier, date of service, provider identifier, point of service, claim type, date processed, and claim line identifier; comparing, using the coding conflict engine the coding of services billed, processed, and paid for an episode of care to capture claim data for undelivered but paid services for review; and reviewing items captured to determine whether a billing error has occurred and is to be reported or excluded from reporting.

In one aspect of the method, an episode of care comprises a circumstance when one or more medical services, procedures, or treatments are administered to a patient needing medical care for an injury, disease, or other health condition by a provider or facility. In another aspect, the procedure and facility codes comprise one or more types of codes selected from the group consisting of CPT, DRG, ICD9/ICD10, and physician specialty codes for medical procedures, diseases, and services.

In another aspect, the step of comparing comprises the steps of cross coding in the coding conflict engine the filtered procedure and facility codes to identify coded items submitted for an episode of care that are inconsistent with each other and therefore in conflict with each other; and associating a flag character with claims for services billed, processed, and paid for undelivered services. In another aspect, the step of comparing further includes, following the step of cross coding, the steps of accumulating coded items that are in conflict and therefore inconsistent with each other in a record, or excluding coded items that are not in conflict.

### BRIEF DESCRIPTION OF THE DRAWINGS

FIG. 1 illustrates a system block diagram of one embodiment of the present invention;

FIG. 2 illustrates a first portion of a system flow chart of the invention performed by the system of FIG. 1;

FIG. 3 illustrates a second portion of the system flow chart of FIG. 2;

FIG. 4 illustrates a flow chart of the “cross-coding” portion (the coding conflict engine) of the flow chart of FIG. 3;

FIG. 5 illustrates a sequence of comparisons performed by the coding conflict engine to identify conflicts among the claims for an episode of care;

FIG. 6 illustrates a table of the claims paid for one example of an episode of care;

FIG. 7 illustrates a set of individual tables listing each conflict identified to illustrate the outcome of the action of the conflict coding engine according to the process and operation depicted in FIGS. 3, 4, and 5; and

FIG. 8 illustrates in tabular form the results of the analysis of the claims including the monies saved.

### DETAILED DESCRIPTION OF THE INVENTION

### Introduction

Typically the medical treatment of a single individual can involve many providers or facilities and incidents of care, all of which will each form the basis for creating a billing record that becomes part of the record submitted as a claim for payment for the services rendered during an episode of patient care. An episode of care includes all clinically related services and procedures for one patient, covering one healthcare encounter (and typically in one day of service) across all settings of care, i.e., places, providers, services, and procedures. Thus, the set of multiple claims for payment associated with a complete episode of care for a patient can be complex to manage and process without errors. However, it is well known that up to approximately 8% of such claims result in payments to providers that should not have been presented for payment because the services billed were not received by the patient. Services billed but not received by the patient may include those services not correctly coded, conflicting or unrelated medical procedures, whether or not these billing errors occurred intentionally. Other types of errors include coding errors due to unbundling, mutually exclusive and incidental procedures, duplicate claims, etc. There are a number of reasons for these errors, and for the inability of conventional claims payment systems to discover all inconsistent claim errors.

One source of error is that claims are often processed asynchronously or independently over a period of several days, weeks or even months, rather than capturing all of the incidents of care associated with the needs of a patient for one visit to a provider or facility for treatment or other medical services. This arises because claims are typically processed in FIFO sequence, one at a time and thus are not readily associated with each other. This is a serious impediment. Another source of error is that current claims payment systems do not accumulate history well or question new/incoming bills based upon prior or associated paid bills for the same patient. Conventional claims adjudicating software and systems too frequently lack the ability to detect such incidents or to perform a sufficiently comprehensive review of services delivered to the patient. Another important reason that a solution has not yet emerged is the sheer volume of information that must be examined—the universe of all paid claims for services delivered to a patient—and the complexity of any possible remedy for discovering and correcting billings containing substantial errors. Thus far, no comprehensive and practical claim auditing system is known to exist that overcomes these difficulties to correct the very substantial economic losses to the financial mechanisms for reimbursing health care providers for the costs of their services. Capturing all related incidents of care for a patient in one record is an important feature of the present invention. Thus, this “continuity of care” record will generally be referred to as “an episode of care” or “episode of patient care” herein. This, among other things, overcomes the FIFO problem mentioned above.

In an advance in the state of the art, the present invention provides a system and method for use by medical claims payors, for example including claims administrators, insurance carriers, unions, government entities, or fully or partially self-funded employer groups, collectively, “clients,” herein as will be explained. The system and method, operated by a “host provider” of the system, enables identifying and correcting billing errors in high volume billing and claim adjudicating systems. The system and method provides recipients of claims for payment—the payor clients of the host provider herein described—with a comprehensive and thorough resource for determining errors in claims and recovery of overpayments in settling of claims.

The key insight into solving the problems discussed above that resulted in the present invention is that only by examining the entirety of a patient's experience in an episode of patient care in seeking and receiving medical care including diagnosis and treatment is it possible to perform the complex analysis and processing of information to reveal services that were billed, perhaps even correctly billed, but, because nothing in the patient's actual medical record supports the services identified in a particular bill, those billings are at least suspect if not completely false. The entire record for an episode of patient care in the medical care system should fully and accurately document the “continuity of care” services, a term that highlights the arena of interest in identifying and correcting billing errors in high volume billing and claim adjudicating systems. The present invention provides a practical way to examine the continuity of care for a patient to verify whether or not a bill received and paid by a third party payor should have been paid (or even, in some cases, should be paid).

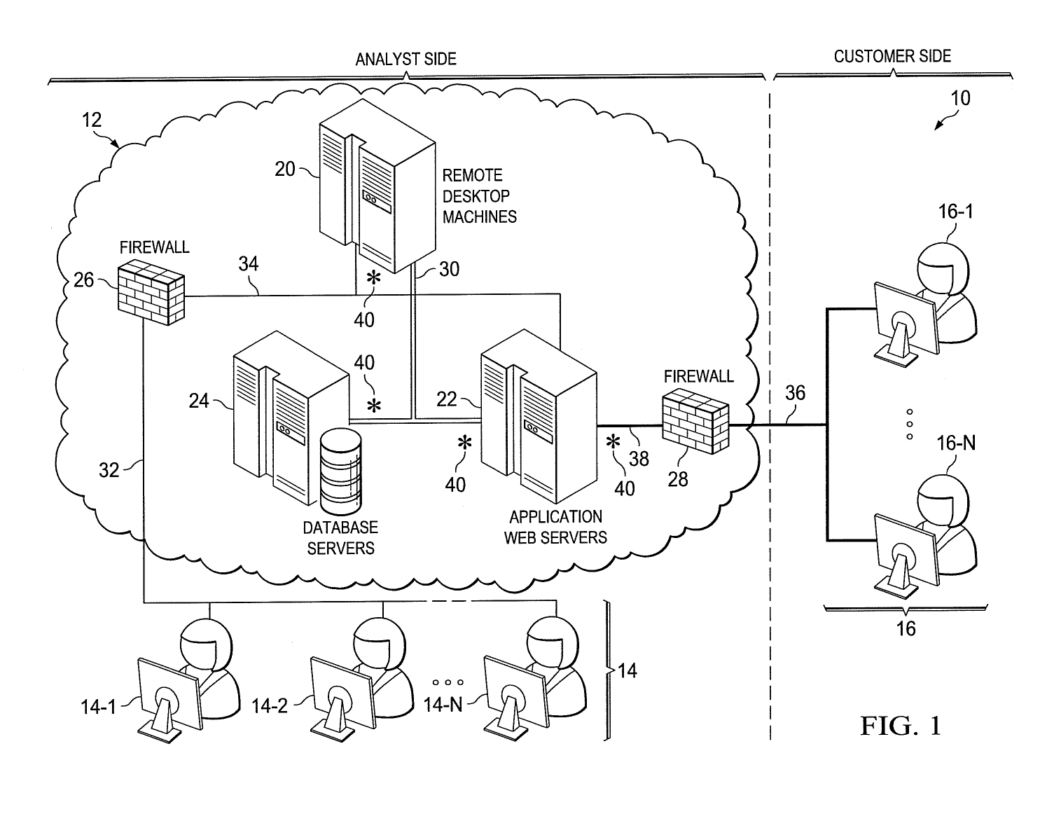

The Auditor system that resides on the provider's website (see FIG. 1) and devised to examine the billing of the episode of care (EOC) for a patient comprises a hosted server environment that includes a coding conflict engine operating in conjunction with a sequence of process steps to examine or audit claims paid by a third party payor for services that were not supported by the record for the episode of patient care. The coding conflict engine includes a rules engine configured to examine claims having coded medical provider or facility services associated with an episode of patient care in a sequence of pattern matching steps to cross match codes defining a first claim for medical provider or facility service as a reference claim with each subsequent claim in the episode of patient care containing medical provider or facility service codes, to identify codes in each examined claim that are in conflict—and therefore inconsistent—with the codes contained in the reference claim, and assign a flag to each code found to be in conflict, wherein the flag represents a medical service billed, processed, and paid but not delivered, and absence of a flag represents coded data that are not in conflict; and a file system to accumulate claims data for the episode of patient care that are processed in the coding conflict engine and may be flagged for further review and recovery of incorrectly paid claims. This innovation will be described in the detailed description that follows.

Briefly, the system and method performs its complex analysis by combining EDI billing information of health care service provider medical claims with payor claims adjudication system output data; cross walking the respective data fields; scrubbing that combined data to amend or remove data that is incorrect, incomplete, improperly formatted, or duplicated to eliminate from further consideration claims or claim lines reflecting zero sum paid; filtering (with unique procedure and facility codes) and sorting the resulting output according to individual patient identifier, date of service, health care provider identifier, and provider and facility coding (such as CPT, DRG, ICD, physician specialty coding, etc.) to compare and flag services billed, processed, and paid, but likely never performed or not received by the individual patient. These flagged items may then be reviewed by other external programs and a claims analytics expert to determine if an error has occurred and will be reported for recovery.

The audit process includes a suite of software edits and algorithms that run in the hosted server environment (See FIG. 1), and further may include the intervention of programmers and analysts at selected points to identify post payment and pre-payment claims that fall out of bounds of proper coding, procedure and payment, thereby to automatically detect coding errors related to unbundling, mutually exclusive and incidental procedures, duplicate claims, etc., regardless whether the errors occurred intentionally or unintentionally. The editing process provides a patient record of all clinically related services and procedures for one patient, covering one healthcare incident or encounter (e.g., date of service), across all settings of care in the episode of patient care.

### Overview of the System and Method

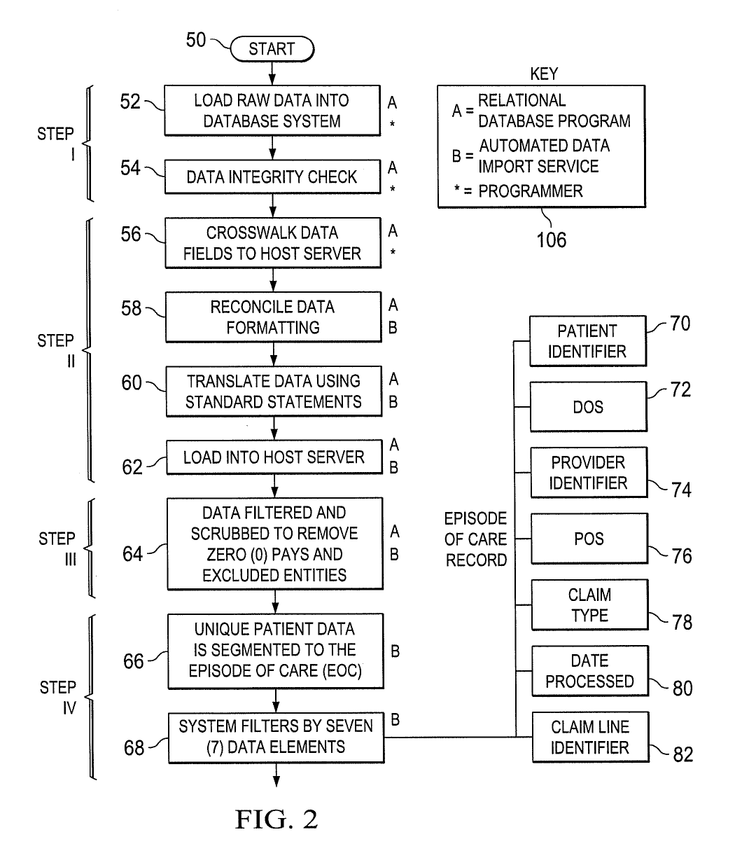

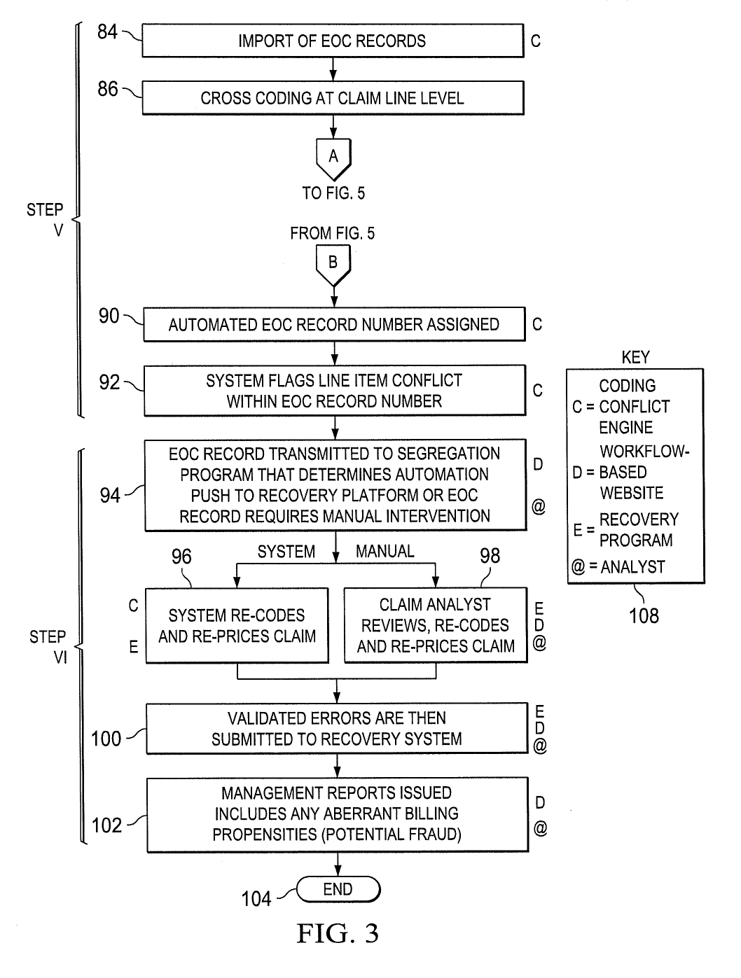

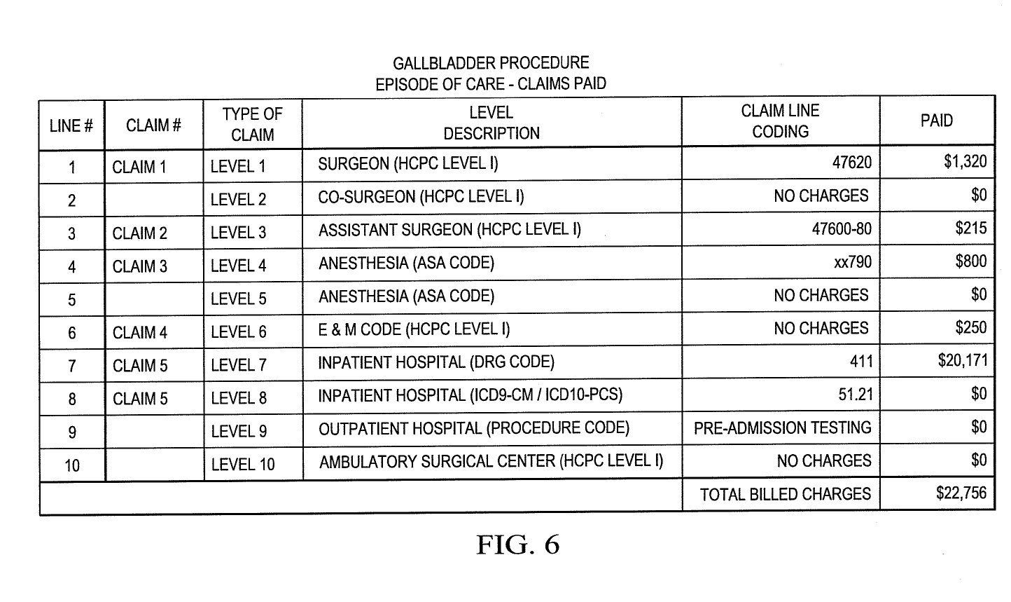

The system shown in FIG. 1 performs six major Steps as depicted in FIGS. 2 and 3. Briefly, the first three Steps I, II, and III respectively enter, cross walk and load, and scrub the data to prepare it for the steps of sorting and filtering, capture and analysis for conflicts among the data, and review that follow. Step four (IV) isolates all medical claims for a particular member or patient billed by a provider by identity and date of service. Step five (V) performs a cross coding of the claims data for each of the providers participating or associated with the episode of patient care recorded in the continuity of care record to determine conflicts among the reported codes, which represent inconsistencies that likely represent claims paid in error. Step V may include generating a listing of claims for viewing on a graphical user interface, which may then be exported to a spreadsheet format, to be described in FIGS. 6, 7, and 8. Step six (VI) provides mechanisms for review of the results of the cross coding of claims data in the coding conflict engine during Step V, to determine appropriate handling to recover payments for erroneous claims.

Step V is the locus of one aspect of the technical advance embodied in the present invention. The following brief introduction is provided to explain why it is an innovation. The insight of the inventor that led to the inventive process to be described herein is that a bill for complex medical and healthcare procedures and services must be reviewed in the context of the patient's entire record or medical history for evidence of properly correlated services and procedures to support the validity of all claimed line items in an episode of care covered by a bill under review. One important objective of this process is to identify the services and procedures incorrectly coded or never received by the patient in that episode of care, and take appropriate steps to recover payments made for these incorrectly billed services and procedures.

The further insight of how the information in the episode of care and the medical record could be reviewed led to the concept of cross-coding of the coded information reported by the provider in the billing for medical services; in other words, the review must take place at the level of the codes—for example—the CPT and other codes (listed below) used by the providers to report the services rendered and the procedures performed. The innovation is to review all of the claims for the entire episode of care—i.e., in the context of the patient's medical history—instead of just looking at or analyzing a current bill or claim in isolation, and to use the cross-coding technique to perform this review.

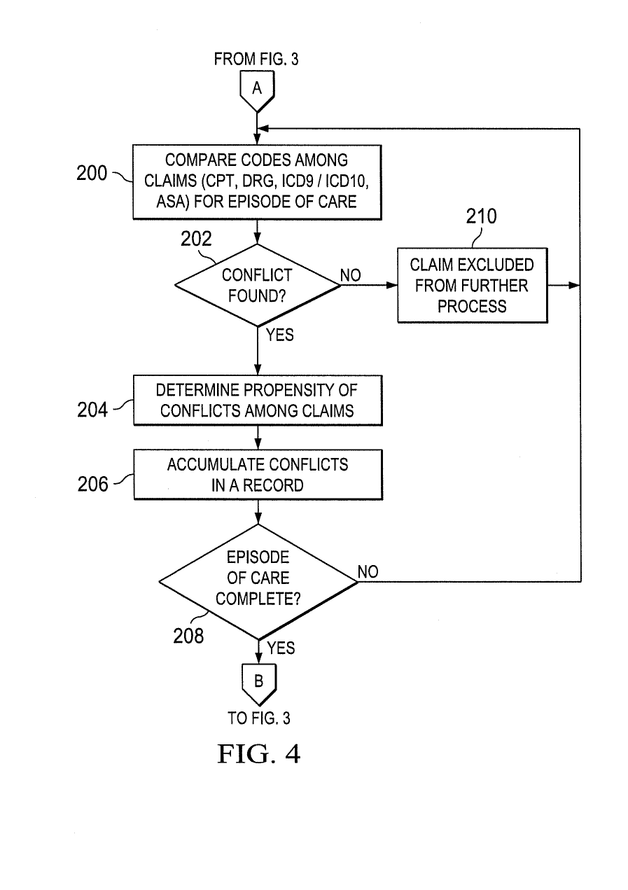

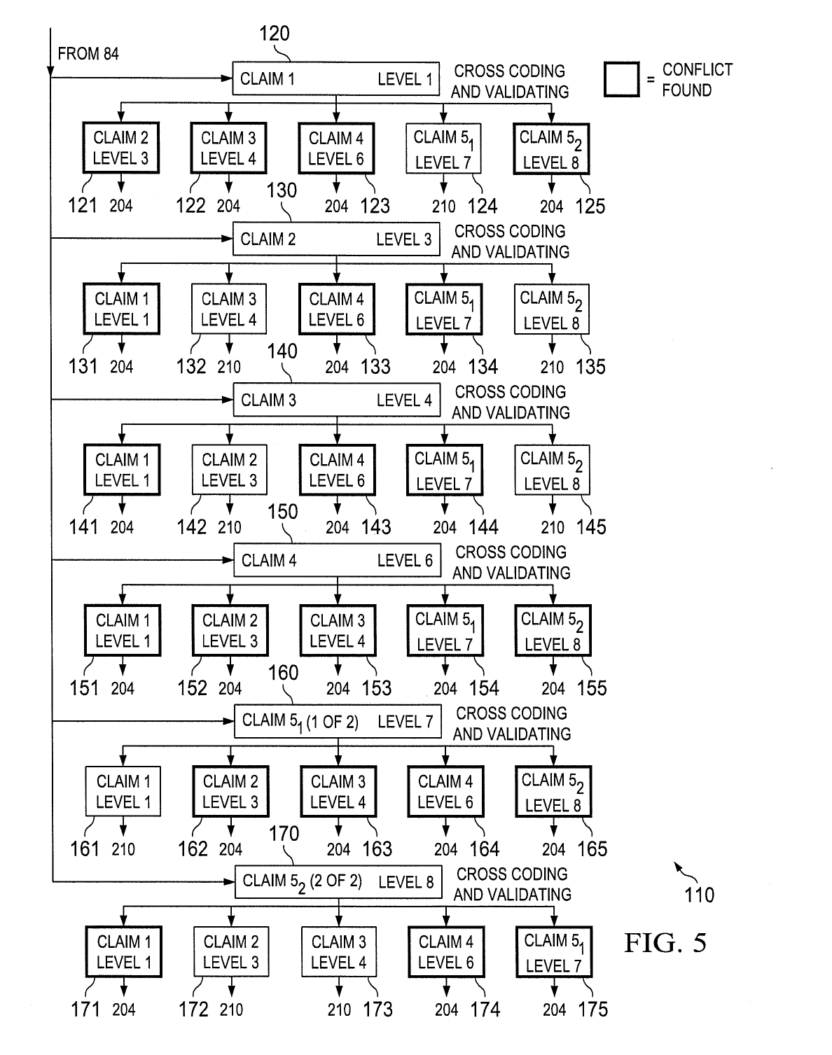

The cross-coding technique, performed by the coding conflict engine 110 (see FIGS. 4 and 5) and further described in FIGS. 2, 3, 4, and 5 is a novel process that examines the service codes reported in the claims data elements by providers. The data elements are derived from industry standard reimbursement and coding guidelines established by Federal, State, and commercial health care plans, and professional associations such as the American Medical Association, the American Hospital Association, and various physician specialty associations of anesthesiologists, orthopedists, surgeons, etc. These codes include but are not limited to HCPC (Health Care Common Procedure Codes), CPT (Current Procedural Terminology) codes, DRG (Diagnosis Related Group) codes, MDC (Major Diagnosis Category) codes, (ICD9/ICD10 (International Classification of Diseases) codes (Rev. 9 and 10 respectively), and codes provided by physician specialty organizations such as the ASA (American Society of Anesthesiologists), etc. The process enables discovery of codes for services and procedures in an episode of care that are inconsistent—i.e., in conflict—with the other line item provider, procedure, and service codes for that episode of care. It then determines which of these inconsistent codes are anomalies that should be denied, edited or subject to a request for correction, or diverted for further review so that wrongly paid claim charges billed can be recovered or adjusted.

Step VI, which may be performed in conjunction with an experienced analyst, enables identification and flagging of claims that warrant investigation, either on an on-site audit visit, or via follow up questionnaires or correspondence with the service providers, or by using external resources such as the Center for Medicare & Medicaid Services (CMS). This Step VI closely reviews all claims, for one date of service, for aberrant practices revealed by the coding conflict engine such as: incorrect reporting of diagnoses or procedures to maximize payment; billing for services or supplies not received (including appointments a patient failed to keep); billing for services by an outlier practitioner as opposed to respective peers; billing discrepancies between facility and professional claims; billing for non-covered services or that are actually covered by another provider or that are for more units than delivered; services delivered by an unlicensed provider under the name of a licensed provider; and billing an inappropriate provider specialty for the service actually rendered. Step VI may also include recovery actions to be described.

### DESCRIPTION OF THE DRAWING FIGURES

FIGS. 1 through 8 of the accompanying drawings illustrate one embodiment of the invention described herein to enable description of the concept of the invention. Persons skilled in the art will readily appreciate that the concept may be embodied in various forms for various specific applications. Accordingly, the figures and the description presented herein are not intended to be limiting but exemplary of the inventive concept.

FIG. 1 illustrates a system block diagram of the embodiment of the invention described herein. The system 10 includes a hosted server environment or domain 12, which is also the locus of the website of the host provider that provides the audit services of the present invention described herein. The domain 12, is shown enclosed within the “cloud” in the figure, and includes remote desktop machines 20 for use by the employees of the host provider of the audit service described herein. The desktop machines 20 are shown connected to system application web servers 22 and to the internal side of a first firewall 26 via an encrypted provider side data link 34. The system application web servers 22 are also connected to the internal side of a second firewall 28 via an encrypted client side data link 38 (heavy line). The remote desktop machines 20 are also connected to database servers 24, which store client data, and to the system application web servers 22 via a LAN data link 30 (Thin double line). The LAN data link 30 connects the machines and servers 20, 22, and 24 operating within the host Provider domain or hosted server environment 12.

Interfacing with the hosted server environment 12 via an encrypted, broadband WAN provider or analyst side data link 32 (Thin single line) and the first firewall 26 are external (physical) host computing devices 14 (shown as 14-1, 14-2, . . . 14-N). Similarly, interfacing with the hosted server environment 12 via an encrypted, broadband WAN client side data link 36 (Heavy line) and the second firewall 28 are external (physical) client computing devices 16 (shown as 16-1, . . . 16-N). The hosted server environment and the external host devices 14 form the “analyst side” of the system on the left side of the dashed line in the figure. The customer side of the system includes the external client computing devices 16. Client machines 16 connect to the system website via the encrypted data links 36, 38 to proprietary software on the application web servers 22. The hosted server environment 12 may be located in a secure data center having full backup and disaster recovery facilities. Threat mitigation and firewall software indicated in the figure by an asterisk * is operative at each of the servers 20, 22, 24 within the hosted server environment 12. The servers 20, 22, 24 may be allocated resources (CPU and memory, for example) of a virtual machine pool. The Host Provider website is accessed on the application web servers 22. In operation, the external host provider computers 14 are operated by the employees of the host provider to control the remote desktop machines 20. The remote desktop machines 20 may be remote controlled virtual computers within the hosted server environment to access the servers therewithin to perform the method described in FIGS. 2 through 5.

The system and method described herein operates under the control of a suite of applications configured and organized to perform the system processes for auditing claim billings and payments. The method preferably includes the following major process steps or sections.

Step I of the illustrative method or process loads the raw data in the format it is received from the designated payor (Client) into the host provider (the analyst entity performing the audit) database, followed by a data integrity check, essentially an automated step. Step II iteratively performs the cross walk operation, perhaps in cooperation with a programmer and analyst, to identify key elements in the raw data and “cross walk” the data fields to the appropriate host provider proprietary definition to reconcile the format of the received field data with the validity check fields of the receiving format. In one implementation, the data can be translated in an automated process performed by an IT programmer using standard statements loaded into the host provider file format. The cross walk process may also be performed in manual steps in conjunction with automated steps. In brief, an analyst reviews each data element, translates it, and then cross walks each field into the host provider standard format.

The data is then automatically scrubbed in Step III to remove data that is incorrect, incomplete, improperly formatted or duplicated, and claims that have lines showing $zero sum paid, etc. Further filtering and sorting of the data, including segmenting the data to the episode of patient care, begins in step four to be described. The segmenting step refers to a process that both parses the claim data from the patient record and assembles it into a form in which the inconsistencies in the claim record can be detected.

Data for a patient medical encounter specific to the episode of patient care is aggregated in the sorting Step IV, including the following elements of the patient's record for the episode of care: (a) patient identifier; (b) date of service; (c) service provider or facility identifier; (d) service coding; (e) type of service provider identifier; (f) place of service; (g) benefit type identifier; (h) date processed; and (I) claim and line identifier. Typically, one healthcare encounter takes place on one day of service across all settings of care (i.e., kinds of service). So-called “span dates,” which denote encounters that take place on two or more days of receiving services, encompass the span of time from beginning to end of an encounter or episode of care. When a span date is evident from the claim record, all services within the span of time are thus considered as part of the episode of care.

Capturing of the data occurs in Step V by compiling and funneling all medical expenditures specific to the patient and the date of occurrence, then segregating the data for each medical occurrence as identified in the database. Here, a cross-coding rules engine, functionally a coding conflict engine 110 that includes a pattern matching mechanism, is utilized to examine and identify coding conflicts among the providers of services identified in the claims submitted to the payor. Conflicts occur when the codes entered for one claim for specific procedures, services, or treatments are inconsistent with the codes entered for another claim for related procedures, services, or treatments. In an entire episode of patient care, for example, there may be numerous distinct claims submitted by different providers. In one example to be described in detail herein with reference to the drawings, the first claim of a provider is designated as a reference claim to which all other claims in the episode of patient care are compared. For each pair of claims being compared in the conflict coding engine 110, if the respective codes reported by the provider are inconsistent, a conflict is declared and the conflict coding engine 110 reports the codes in conflict by inserting the conflicting data in a spreadsheet file, for example. This step five captures procedures or services or treatments that may have been coded, billed, processed, and paid but likely never delivered to or received by the patient.

Finally, in Step VI, the system passes the information from step five for review operations performed by a proprietary software program and one or more claim analyst experts.

The following example of the operation of the process outlines the major steps of the audit process in flow chart form, shown in FIGS. 2 through 5. The process implements the six major Steps I through VI described above. FIG. 2 illustrates a flow chart of a first portion of one embodiment of the method implemented by the system of the present invention. FIG. 3 illustrates the second portion of the flow chart of FIG. 2. FIG. 4 illustrates details of step 86 of FIG. 3, as an example of the cross coding process that takes place in the coding conflict engine 110. FIG. 5 illustrates the process that follows step 86 before returning to step 90 in FIG. 3. The following description will treat them together as parts of a single process for analyzing billing data for submitted claims and the corresponding claims adjudication data to determine recovery of overpayment.

It will be observed that the individual steps illustrated in FIGS. 2 and 3 include notations indicated by the letters A, B, C, D, and E, an asterisk *, and the @ symbol. These notations associate the process software involved in performing the notated step. In FIG. 2, the letter A represents a relational database program, B an automated data import service, and an * indicates that a programmer may be involved in the step. Similarly, in FIG. 3, a letter C represents operations that take place in the coding conflict engine 110, D the operations that take place via the website, E the recovery program, and the @ symbol indicates that a skilled analyst may be involved to facilitate the individual steps of Step VI.

The process starts in FIG. 2 at step 50 followed by a combining step 52, which combines EDI billing data of health care providers, claim-by-claim, with prior entities' claim adjudication system output data. This step is basically one of loading the raw data so that billings and claims are correctly identified. The step may require both manual and automated data entry, as well as IT programming operations to interpret data, set up computer scripts, and input the data into a dedicated database for processing. A data integrity check follows at step 54. Steps 52 and 54 comprise “Step I.”

The process advances to step 56, a cross walking of the data fields, including procedure codes and facility codes, to further prepare the data for analysis. It may be an iterative process involving check sum and quality control passes, and may include algorithms used to reconcile the format of key fields of data to the format of corresponding validity check fields in the system. Also required may be intermediate steps for cross walking the key fields to appropriate system definitions. The term “cross walking” means in this context the cross-comparison analysis of two different, often disparate, sets of data. Steps 52 through 56 may be performed by a programmer running a relational database program.

In steps 58 through 62, the process continues by reconciling the data formatting in step 58 and translating it in step 60 using standard statements to amend or remove data that is incorrect, incomplete, improperly formatted or duplicated. The reconciled and translated data is then loaded into a host server, which completes the major Step II of the method. This part, steps 58-62, of the process may be fully automated using the relational database and an automated data import service as indicated by the capital letters A and B alongside the respective steps in FIG. 2.

Step 64 implements major Step III, again using the relational database program A and data import services B to filter and scrub the data to remove zero (0) pays and excluded entities. Zero pays, as is well known in the industry, are claims having a zero sum paid or in which the claimed payment was reversed. This step removes claims that do not need to be examined for inconsistent claimed services or procedures to identify overpayments.

Thereafter the method proceeds to step 66 to perform a process that parses the unique patient data of the episode of care and then in step 68 filters (sorts) it. This process is denoted a ‘segmenting step’ for parsing or extracting patient and provider identity, date and place of service, claim type, date processed, and assigning a claim line identifier in the steps 70 through 82 as shown in FIG. 2. These process actions, which may continue the use of the automated data import service B, comprise major Step IV to compile the episode of care record, i.e., prepare the claim data for the cross coding of the data in Step V beginning with step 84.

Turning now to FIG. 3, the method proceeds by entering major Step V, utilizing the conflict coding engine 110, also identified by the letter C″ next to the statements of Step V. Beginning with step 84 the coding conflict engine proceeds to cross code the claim data for each claim of the episode of care with each other claim in the episode of care to locate and identify the inconsistent data among them. The records for the episode of care (EOC) are imported in step 84 and thereafter to the cross coding function at the claim line level in step 86. The process of step 86 is illustrated in FIG. 4. In an example of the cross coding of an episode of care record in the coding conflict engine, the sequence of comparisons is illustrated in FIG. 5. FIGS. 6, 7, and 8 depict the outcome of the cross coding in tabular or spreadsheet forms that identify the coding conflicts in the claims. In brief, if no conflicts are found in step 202 among the codes of an individual claim from a provider in the coding conflict engine 110 (FIG. 5), the process of FIG. 4 advances to steps 210 and 200 in FIG. 4, and that claim item is excluded from further cross coding processes. If, however, conflicts are found in step 202 among the codes, the process of FIG. 4 continues with step 204 through steps 206 and 208, thereafter returning to step 90 in FIG. 3 when all of the claim items in the episode of care have been reviewed. FIG. 4 will be described in detail herein below.

Continuing with FIG. 3 at step 90, which assigns an episode of care record number to the file accumulating (see step 206) the identified claims data that are in conflict, the flow advances to step 92 wherein the system flags the line item conflict within the episode of care record number. In the following step 94 the episode of care (EOC) record is transmitted to a segregation program that determines whether the record will be processed automatically or manually, according to criteria such as the number of conflicts in an episode of care. For example, if only one conflict is found in an episode of care, the record may be processed automatically; and if more than one conflict is detected, then manual intervention may be needed. If the criteria are not met, the flow advances to step 96 for the system to re-code and re-price the claim under review. If the criteria are met, the flow advances to step 98 to present the claim to an analyst to intervene and manually re-code and re-price the claim. These steps in effect validate the conflict errors, which can then be submitted in step 100 to a recovery system to proceed with actions to recover mis-paid or over-paid claims. Step 102 follows, to prepare reports regarding the conflicts identified and validated, which, in some cases may include identifying aberrant billing practices indicating, for example, potential fraud. Thereafter the process ends at step 104.

FIG. 4 illustrates a flow chart of the “cross-coding” portion (the coding conflict engine) of the flow chart of FIG. 3. The process begins at step 200 to compare the codes among the claims of the episode of care, being codes such as CPT, DRG, ICD9/ICD10, and physician specialty codes such as ASA (Anesthesiology Society of America), etc. Test step 202 determines whether a conflict among the codes is found. If Yes, the flow advances to step 204 to determine the propensity of conflicts among the claims, which means to examine all claims related in the episode of care for conflicts and, in step 206, then accumulate the conflicts in a record. If the examination of all of the claims in the episode of care has been completed, as tested in step 208, the process returns to FIG. 3 at step 90; otherwise the process returns to step 200 to examine the next claim. Similarly, in step 202, if no conflict was found in a claim, then that claim is excluded from further analysis in step 210 and the flow returns to step 200 to examine the next claim.

FIG. 5 illustrates in tabular form the sequence of comparisons performed by the coding conflict engine to identify conflicts among the claims for an episode of care. First, a word about the structure depicted in FIG. 5. It basically depicts a set of flow charts to be executed in sequence. The steps are numbered 120 (Claim 1) to 130 (Claim 2), to 140 (Claim 3), to 150 (Claim 4), to 160 (Claim 5—1^{st} provider, designated Claim 5₁=Level 7), to 170 (Claim 5—2^{nd} provider, designated Claim 5₂=Level 8). Note that each “Level” corresponds to a particular provider or type of provider that submitted the Claim. Thus, each of these steps, which perform the cross coding and validating functions in the coding conflict engine, represents one claim item (“Claim No.”) submitted by one provider (or facility) of a healthcare service (or diagnosis or treatment), designated as the “Level” or type of provider. Thus, for example, Claim 1, Level 1 (box 120) represents a claim line item #1 entered by a provider #1, which may be a surgeon, as shown in FIG. 6 at Line #1 (left-hand column) in the first line of that table. The claim line coding for this Claim 1, Level 1 is shown as 47620, (for which a payment of $1,320 was paid by the payor). This Claim line item serves as the reference for the cross coding of the remaining claim numbers. These Claim numbers (#) also appear in Column 2 of FIG. 6.

Continuing with FIG. 5, and proceeding from step 120, the flow advances to examine the reported codes in the remaining Claims 2, 3, 4, 5₁, and 5₂ with the codes in Claim #1, looking for conflicts among them. If a conflict is found (NOTE: the process is in step 202 at this point), the flow proceeds to step 204 (FIG. 4) and highlights the box in FIG. 5 wherein the conflict occurred. In this example, in the first box 121 that compared Claim 2, Level 3 with Claim 1, Level 1, these two claims were found in conflict, indicated by the broad border surrounding box 121. The conflict in this box is between the Surgeon (Claim 1, Level 1) and the Assistant Surgeon (Claim 2, Level 3). In this episode of care, the code submitted by the Assistant Surgeon, 47600-80, is not consistent, for a gallbladder procedure, with the code submitted by the Surgeon, 47620. Thus, these two codes are in conflict. Thereafter, the conflict is accumulated in a conflict record in step 206, and a test is made at step 208 to determine whether the entire episode of care has been examined. In this case, the outcome is NO, and the flow returns to step 200 to examine the next Claim at step 122 (FIG. 5), which is Claim 3, Level 4. This process continues through steps 122, 123, 124, and 125 before advancing to step 130, Claim 2, Level 3, to examine that claim with the others, beginning with Claim 1, Level 1 at step 131, then Claim 3, Level 4 at step 132, etc. Note that in this group, Claim 2, Level 3 becomes the reference claim for the cross coding of the remaining claim numbers, including Claim 1, Level 1, which served as the reference in the first group. The same pattern and sequence is repeated for each Claim, in the respective steps 130, 140, 150, 160, and 170.

Notice that in examining the codes for conflicts in the first group of FIG. 5 (steps 121 through 125) that the codes in steps 121, 122, 123, and 125 were found to be in conflict as indicated by the broad border around those steps. Step 124, however, did not result in a conflict. Thus, the flow follows the path to step 210 in FIG. 4, where the claim is excluded from further processing.

FIG. 6 illustrates a table of the claims paid for an episode of care for the illustrated gallbladder procedure analyzed in the example of Claim 5. The table lists the Claims—there are six—in the 2^{nd} column and the type of claim (3^{rd} column) along with the type of provider or facility (Level Description in the 4^{th} column), the claim line coding (5^{th} column), and the amount paid by the payor on that particular claim. The 3^{rd} and 4^{th} columns define the same parameter, just in different ways. A “no charges” entry means that there was no claim submitted by the provider or facility shown in the 4^{th} column. A “deny edit” or “Edit/Deny” entry means that the item should been denied (edited from consideration for payment). Sometimes a provider may have performed a service but did not submit a claim, as in line #9, the outpatient hospital, for “pre-admission testing.”

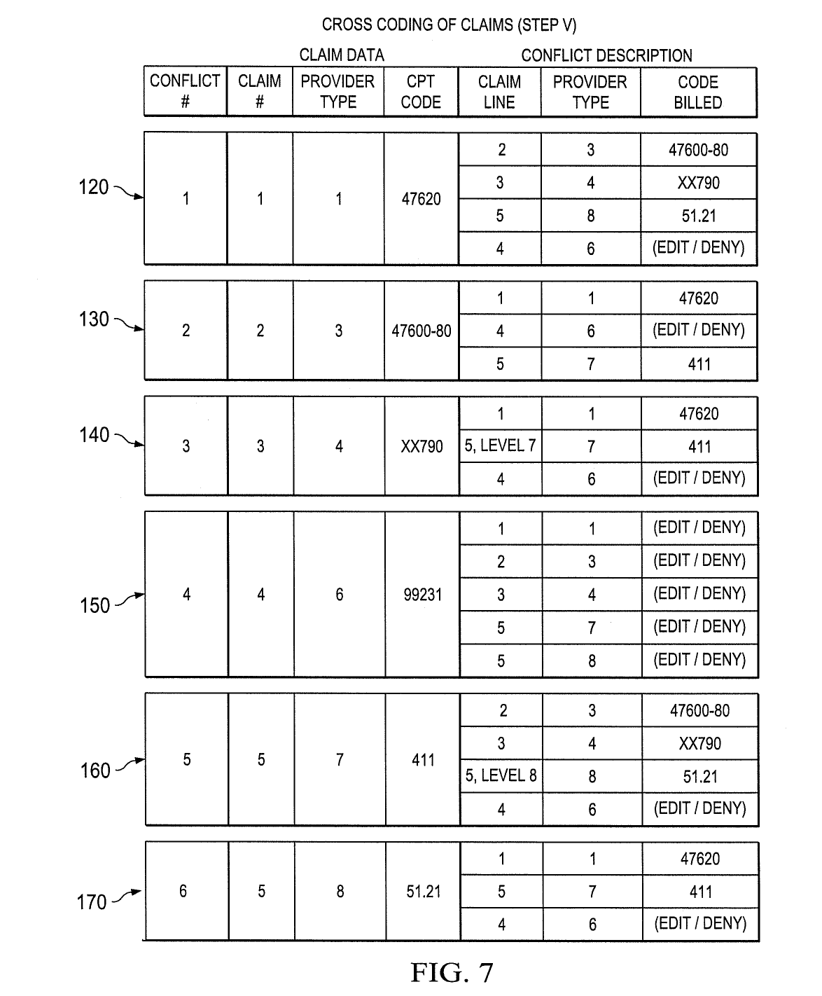

FIG. 7 provides a set of tables that list the conflicts identified for each claim # and the step in FIG. 5 (120, 130, 140, 150, 160, 170) in which the conflicts occurred. the conflict set number shown in the first (lefthand) column. The claim data is shown in the second, third, and fourth columns. The conflict descriptions are contained in the right hand side of the table in columns 5, 6, and 7, respectively by claim line, provider type, and code billed on the claim.

Thus, for Claim #1, provider type 1 (Level 1, surgeon), who submitted a claim listing code 47620, Claims 2 (code 47600-80, assistant surgeon), 3 (code xx790, anesthesia), 5 (code 51.21, in patient hospital), and 4 (code edit/deny, E&M code) were all found to be inconsistent with the code 47620 in Claim #1.

For Claim #2, provider type 3 (Level 3), who submitted a claim listing code 47600-80, Claims 1 (code 47620), 4 (edit/deny), and 5 (code 411) were all found to be inconsistent with the code 47600-80 in Claim #2.

The analysis for the Claim numbers 3, 4, 5₁, and 5₂ are similar.

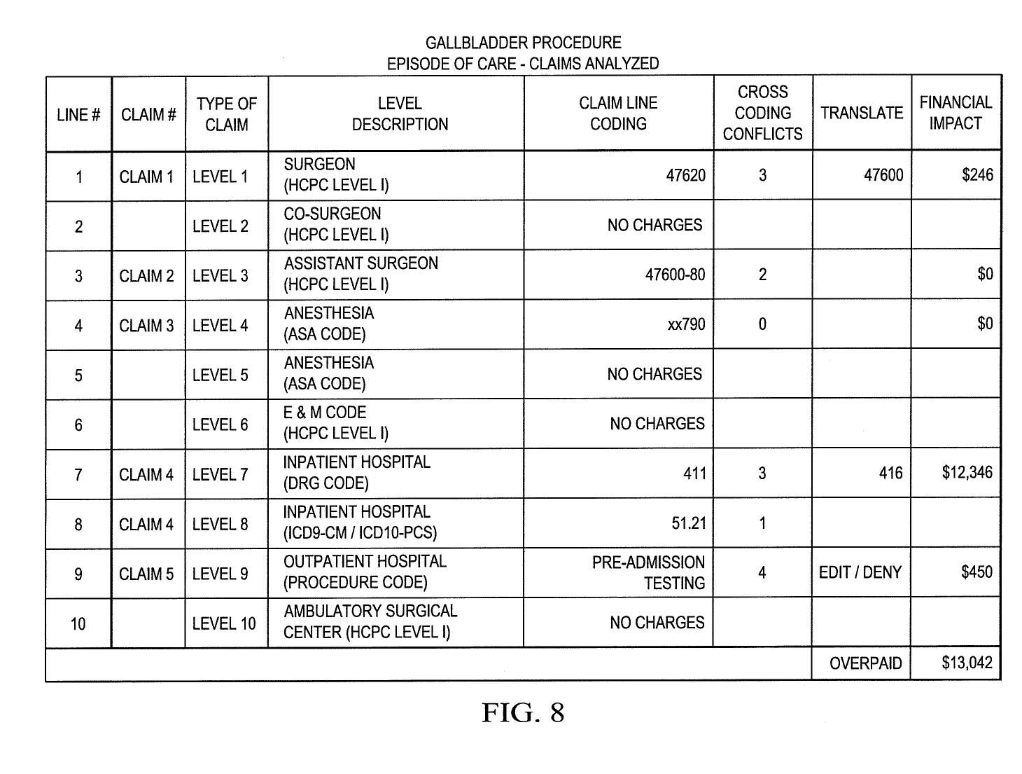

FIG. 8 illustrates in tabular form the results of the analysis of the claims including the monies saved. The left-hand five columns of FIGS. 6 and 8 are identical. This table is very similar to FIG. 6 except for the three columns on the right side of the table. The column labeled “Cross Coding Conflicts” states the number of conflicts that are identified with a specific level—i.e., provider. The next column, labeled “Translate” states the code that should have been applied for that provider level. The last column to the right lists the financial impact of identifying the conflicts among the claims for the episode of care that resulted in overpayments. In this example of an episode of care, the total overpayment was $13,042. Thus, of the $22,756 originally billed, the recovery of the overpayment will reduce the net bill to $9,714.

### CONCLUSION

The foregoing describes a system and method or process, and includes one detailed example, for auditing and analyzing coded claims for payment that are associated with one encounter or episode of medical care that involves multiple services. Such claims, depending on how they are prepared, submitted, and processed may include many opportunities for error and thus may include overpayment for some of the services identified in coded form on the billing documents that were not actually delivered.

Briefly described, the invention broadly comprises the combination of a coding conflict engine, which includes a pattern matching engine that is used in a new way, with certain process functions. The combination compares the codes, for multiple claimed services, treatments, procedures, etc. that are rendered by medical care providers and facilities during an entire episode of medical care with each other, to discover which of the codes among them are inconsistent. Thus, concisely, referring to FIGS. 2 and 3, and following the input of claims data into to it (Step I), a system and method are provided that identifies coding errors in claims for an episode of medical care, comprising (Step II) a process that translates into one format, input claims data that encode multiple health care services delivered in an episode of care for a patient; (Step III) a process that pre-sorts the claim data by excluding claim data that is incorrect, incomplete, duplicated, and improperly formatted; (Step IV) a compiling process for gathering claims data for the episode of care; and (Step V) a coding conflict engine for comparing the data in each claim of the episode of care with the data in all other claims in the episode of care to determine inconsistencies in the record. A final Step VI, to process the results to decide how to recover incorrect payments may be included. It will also be recognized that in many uses of the present invention, Steps I and VI may involve human intervention at least in part.

However, persons skilled in the art will recognize the utility of Steps II through V in a variety of applications to identify errors and inconsistencies in records for services that are encoded for storage, transmission, payment, etc. The exemplary system and method is not limited to audits of healthcare billings and payments, in that the principles of the invention may be applied to audits of other large-scale payment systems that rely on systems of coded data about the services performed and the processes used to submit claims for reimbursement. It is an efficient system and method for discovering the inconsistencies or conflicts in coded claims that record services rendered that are typically documented individually or in a FIFO procedure but are members of a group of associated services for a single entity. Such documentation of services is prone to significant errors when multiple services are rendered or delivered to a single client or entity.

The present invention thus advances the state of the art in the technical field of analyzing, auditing, and reconciling paid health care claims. Naturally, because of their processing speed and abilities to process very large quantities of data, computers and the technologies of computing, and communication are absolutely essential in any system that performs these functions. Nevertheless, such technology is useless without the complex and novel organization of the computing and communication facilities available that are needed to provide these services in a practical, efficient way. Since the problem solved by this invention is a persistent problem not heretofore provided with a solution, a long sought improvement in the operation of this technology is described herein, which meets the substantial need for examining an entire patient record for inconsistencies in billing.

Accordingly, while the invention has been shown in only one of its forms, it is not thus limited but is susceptible to various changes and modifications without departing from the spirit thereof.

What is claimed is:

1. A method executed by a coding conflict engine in a hosted server environment to detect conflicting medical service and procedure claims submitted by multiple providers and facilities for an episode of patient care, comprising the steps of:
combining, in a data file created by a claim analysis system from respective databases coupled thereto, billing data of the service providers for the episode of care, claim-by-claim, with output data of payor entities who paid claims for that episode of care; and
processing the combined billing and paid claims data in the claim analysis system by executing the following steps in a hosted server environment:
loading raw service provider billing data and payor output data expressed in differing formats into the data file in a database system within the hosted server environment;
cross walking the claim data fields of the service provider's billing data and the payor's output data, including procedure and facility codes for medical services to prepare data for analysis;
scrubbing the cross walked data to amend or remove data that is incorrect, incomplete, improperly formatted, duplicated, or reflecting zero-sum paid;
filtering, using unique procedure and facility codes, the scrubbed data for the episode of care according to one or more parameters selected from the group consisting of individual patient identifier, date of service, provider identifier, point of service, claim type, date processed, and claim line identifier;
comparing, using the coding conflict engine the coding of services billed, processed, and paid for an episode of care to capture claim data for undelivered but paid services for review; and
reviewing items captured to determine whether a billing error has occurred and is to be reported or excluded from reporting.

2. The process of claim 1 wherein an episode of care comprises:
a circumstance when one or more medical services, procedures, or treatments are administered to a patient needing medical care for an injury, disease, or other health condition by a provider or facility.

3. The process of claim 1, wherein the procedure and facility codes comprise:
one or more types of codes selected from the group consisting of CPT, DRG, ICD9/ICD 10, and physician specialty codes for medical procedures, diseases, and services.

4. The process of claim 1, wherein the step of combining comprises the steps of:
interpreting data received from service providers and payor entities for a specified episode of care;
setting up computer scripts; and
importing the data into a system database of the claim return system.

5. The process of claim 1, wherein the step of loading comprises:
processing the raw data in an ETL (extract, transform, load) process adapted for each customer; and
perform a data integrity check to validate the type and source of the raw data.

6. The process of claim 1, wherein the step of cross walking comprises the steps of:
identifying the key fields in the raw data; and
reconciling the format of the identified key fields to the format of corresponding validity check fields compatible with the coding conflicts engine.

7. The process of claim 1, wherein the step of scrubbing comprises the steps of:
eliminating claims that have been adjusted to zero balance and claims payments already reversed in their entirety; and
retaining all other claims for further analysis.

8. The process of claim 1, wherein the step of filtering comprises the steps of:
substituting the unique procedure and facility codes in claims retained for further analysis; and
formatting the retained claims according to attributes defining the episode of care for each claim as defined by individual patient identifier, date of service, provider identifier, and CPT coding.

9. The process of claim 1, wherein the step of filtering comprises:
filtering the scrubbed data for the episode of care according to an individual claim type, date processed, and claim identifier.

10. The process of claim 1, wherein the step of comparing comprises the steps of:
cross coding in the coding conflict engine the filtered procedure and facility codes to identify coded items submitted for an episode of care that are inconsistent with each other and therefore in conflict with each other; and
associating a flag character with claims for services billed, processed, and paid for undelivered services.

11. The process of claim 1, wherein the step of comparing further includes, following the step of cross coding, the steps of:
accumulating coded items that are in conflict and therefore inconsistent with each other in a record; or
excluding coded items that are not in conflict.

12. The process of claim 1, wherein the step of reviewing comprises the step of:
reviewing claims associated with a flag assigned to indicate a conflict in the comparing step for discrepancies between claimed services and delivered services.
determining the disposition of reviewed items in a report or submitted for recovery of amounts paid in error.

13. The process of claim 12, wherein the determining step comprises the steps of:
determining whether the billing errors were isolated or systemic; and
if isolated, prepare and submit request to recover over payment of claim; or
if systemic, submit to management in a report to negotiate recovery of overpayments.

14. A system for identifying coding errors among claims billed by different medical care service providers or facilities in an episode of care that includes multiple billed services, comprising:
a hosted server environment including one or more remote desktop computing devices, one or more host application web servers and one or more database servers, wherein the remote desktop computing devices are coupled via a network data link with the host application web servers and the database servers; and
a coding conflict engine operable in the hosted server environment to compare the coding of services billed, processed, and paid to the medical care service providers for an episode of care to capture claim data for undelivered but paid services for review.

15. The system of claim 14, further comprising:
one or more host computing devices coupled with the host server environment via a first encrypted data link and a first firewall to the remote desktop computing devices and the host application web servers; and
one or more client computing devices coupled with the host server environment via a second encrypted data link and a second firewall to the host application web servers.

16. The system of claim 14, wherein the hosted server environment comprises:
a website operative on the host application web servers;
a suite of software applications for performing claim auditing operations; and
a software application in each server for performing threat mitigation and firewall operations.

17. The system of claim 14, wherein the coding conflict engine comprises:
a rules engine configured to examine claims having coded provider or facility services associated with an episode of care in a sequence of pattern matching steps to cross match codes defining a first claim for provider or facility service as a reference claim with each subsequent claim in the episode of care containing provider or facility service codes, to identify codes in each examined claim that are in conflict—and therefore inconsistent—with the codes contained in the reference claim, and assign a flag to each code found to be in conflict, wherein the flag represents a service billed, processed, and paid but not delivered, and absence of a flag represents coded data that are not in conflict; and
a file system to accumulate claims data for the episode of care that are flagged for further review.

18. The system of claim 16, wherein the suite of software applications comprise:
a claim query section;
a claim editing section;
a section including rules and filters for performing client-specific edits;
a compilation program for identifying incorrect reimbursements; and
an overpayment recovery program operative by human intervention.

19. A system for identifying coding errors in a record of claims for an episode of medical care, comprising:
a process that translates into one format, input claims data that encode multiple health care services delivered in an episode of care for a patient delivered by two or more providers or facilities;
a process that pre-sorts the claim data by excluding claim data that is incorrect, incomplete, duplicated, and improperly formatted;
a compiling process for gathering claims data for the episode of care; and
a coding conflict engine for comparing the data in each claim of the episode of care with the data in all other claims in the episode of care to determine inconsistencies in the record.

20. The system of claim 19, comprising:
segregating inconsistent claims data in the record into a first group for automated recovery processing of a single inconsistent claim or a second group for manual recovery processing of multiple inconsistent claims.

21. A coding conflict engine for detecting conflicts in provider claims for medical services, comprising:
a rules engine configured to examine claims having coded medical provider or facility services associated with an episode of patient care in a sequence of pattern matching steps to cross match codes defining a first claim for the medical provider or facility service as a reference claim with each other claim in the episode of patient care containing medical provider or facility service codes, to identify codes in each examined claim that are in conflict—and therefore inconsistent—with the codes contained in the reference claim, and assign a flag to each code found to be in conflict, wherein the flag represents a medical service billed, processed, and paid but not delivered, and absence of a flag represents coded data that are not in conflict; and
a file system to accumulate claims data for the episode of patient care that are processed in the coding conflict engine.

22. The coding conflict engine of claim 21, wherein the rules engine comprises:
an interface to a first file for receiving, in sequence, a series of claim data having the coded medical provider or facility services associated with an episode of patient care;
a processor for performing the pattern matching steps to cross match codes defining each set of claim data through the codes in the entire sequence of the series of claim data; and
an interface to a second file for receiving claim data for the episode of patient care that are flagged for further review.
